(19) United States
(12) Patent Application Publication
(10) Pub. No.: US 2013/0317836 A1
(43) Pub. Date: Nov. 28, 2013

(54) Systems and Methods for Time Management in a Healthcare System

(71) Applicant: CellTrak Technologies, Inc., Schaumburg, IL (US)

(72) Inventors: Michael K. Wons, Naperville, IL (US); Andrew M. Kaboff, Vernon Hills, IL (US); Steven A. Wegner, Bartlett, IL (US); Zhou Cai, Wood Dale, IL (US)

(73) Assignee: CELLTRAK TECHNOLOGIES, INC., Schaumburg, IL (US)

(21) Appl. No.: 13/896,595

(22) Filed: May 17, 2013

Related U.S. Application Data
(60) Provisional application No. 61/648,429, filed on May 17, 2012.
(60) Provisional application No. 61/668,782, filed on Jul. 6, 2012.

(30) Foreign Application Priority Data
May 17, 2013 (CA) 2816583

(51) Int. Cl. G06Q 50/22; G06Q 10/10

(52) U.S. Cl. CPC G06Q 50/22; G06Q 10/1091
USPC 705/2

(57) ABSTRACT

Embodiments disclose systems and methods for time management in a healthcare system. The method may be executable to receive data indicative of an actual time value associated with a care event and identify an expected time value associated with the care event. The method may be further executable to determine that the difference between the actual time value associated with the care event and the expected time value associated with the care event is within a threshold range. Based on the determination, the method may be executable to process the expected time value associated with the care event instead of the actual time value associated with the care event.

### CROSS-REFERENCE TO RELATED PATENT APPLICATIONS

This patent application claims priority to U.S. Application No. 61/648,429, filed on May 17, 2012, and U.S. Application 61/668,782 filed on Jul. 6, 2012, both of which are currently pending. This application also claims priority to Canadian Patent Application No. (to be assigned, reference number 12-596-CA, Systems and Methods for Time Management in a Healthcare System), filed on May 17, 2013. The contents of these applications are entirely incorporated herein by reference, as if fully set forth in this application.

### BACKGROUND

The healthcare industry is a rapidly growing industry that includes hospital, hospice, long term healthcare, and home care services. The healthcare industry employs tens of thousands of doctors, nurses, assistants, care providers, and other healthcare professionals. These healthcare professionals visit a number of patients and are under time pressures to provide services to the patients in an efficient manner. Keeping track of how much time is spent with patients is helpful when scheduling healthcare professionals for hospital shifts and how many home care or hospice visits to schedule. Payment for healthcare services that are rendered is primarily paid by government programs such as Canadian Medicare programs and United States federal and state Medicare and Medicaid programs. At times, payment for services may be rendered by private pay from insurance companies or individuals. Patient well-being often depends on the visit and attendance compliance of the visiting nurse, aide, or therapist, for example.

Home healthcare agencies dispatch nurses, aides, and therapists to the homes of patients to perform required healthcare assessments, tasks, and other vital services. The frequency and length of time of a visit and the care provided by the visiting care provider are important to obtaining a positive outcome and improving the health of the patient. Government reimbursement to a home healthcare agency is frequently paid on a per episode (sickness) basis; therefore, the visiting nurse is often required to recommend the frequency and type of visits by a care provider.

It is important to ensure compliance by the care provider in attending the needed visits, and knowing what tasks and services are required for a specific patient. Tracking the duration of the actual visit is also important as different paying entities may allot different amounts of time per visit. Care providers that spend too much or too little time caring for patients may encounter problems getting reimbursed for their time.

In addition to tracking how much time is spent with a patient, care providers are often tasked with tracking other metrics such as the distance traveled to the patient's location and/or the amount of time to travel to and/or from the patient's location. Some agencies may reimburse costs incurred in traveling to the patient's location. However, to get reimbursed, this data must be meticulously tracked and recorded. Inaccurate entries can negatively affect the employer's (or other paying entity's) bottom line.

Care providers typically spend considerable amounts of time filling out paperwork to document the amount of time spent with the patient, the number of miles or kilometers the care provider traveled to serve the patient, and the amount of time spent traveling to or from the patient's location. Care providers also spend time having to correct data-entry errors and account for unexplained gaps between patient visits. These gaps may include, for example, the couple of minutes it may take for the care provider to go from the care provider's vehicle to the patient's home. While these durations may start small, they can easily add up by the end of the care provider's reporting period and result in large amounts of time that are not accounted for, and thus not reimbursable. These gaps can also result in messy record-keeping when submitting time for reimbursement. Most concerning, however, is that the large amount of time spent entering time and fixing data-entry errors detracts from the amount of overall time that the care provider can spend with patients.

### SUMMARY

In one example aspect, a method is provided that is executable to receive, by a computing device, data indicative of an actual time value associated with a care event and identify an expected time value associated with the care event. The method may also be executable to determine that the difference between the actual time value associated with the care event and the expected time value associated with the care event is within a threshold range. Based on the determination, the method may be executable to process the expected time value associated with the care event instead of the actual time value associated with the care event.

In another example, a method may be provided that is executable to determine an actual duration of time to perform a care event, wherein the actual duration is based on an actual start time and an actual end time. The method may also be executable to identify an expected duration of time to perform the care event, wherein the scheduled duration is based on an expected start time and an expected end time. A computing device may make a first determination that the difference between the actual duration of time to perform the care event and the expected duration of time to perform the care event is within a threshold range. Based on the first determination, the computing device may adjust at least one of the actual start time and the actual end time.

In yet another example, a method may be provided that is executable to receive an end time value associated with a first care event at a first location and receive a start time value associated with a second care event at a second location. A computing device may determine a duration of time between the end time value and the start time value, and identify a travel time indicative of a time to travel between the first location and the second location. Responsive to the travel time being within a threshold range, the computing device may adjust the travel time to the duration of time between the end time value and the start time value.

Also disclosed herein are structures configured to facilitate implementation of the disclosed methods. One embodiment may take the form of a computing device (e.g., a communication device, computing system, etc.) that includes a communication interface, a processor, data storage, and program instructions executable by the processor for carrying out the functions described herein. Another embodiment may take the form of a non-transitory computer readable medium having instructions stored thereon for carrying out the functions described herein.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

Various embodiments are described herein with reference to the following drawings, in which like numerals denote like entities, and in which:

FIG. 1 is a simplified block diagram that illustrates a system in which embodiments of the disclosed methods and entities can be implemented;

FIG. 2 is a functional block diagram that illustrates a communication device used in a computing system;

FIG. 3 is a schematic diagram that illustrates a conceptual partial view of an computer program product that includes a computer program for executing a computer process on a computing device;

FIG. 4 is a simplified block diagram that illustrates a timeline of events;

FIG. 5 is a flow diagram that depicts functions that may be included in the computing system to facilitate implementation of the methods described herein;

FIG. 6 is a flow diagram that depicts functions that may be included in the computing system to facilitate implementation of the methods described herein;

FIG. 7 is a flow diagram that depicts functions that may be included in the computing system to facilitate implementation of the methods described herein;

FIG. 8 is a pictorial diagram that illustrates a user interface view of data associated with one or more care visits; and

FIG. 9 is a pictorial diagram that illustrates a user interface view for data modification procedures.

### DETAILED DESCRIPTION

In the following detailed description, reference is made to the accompanying figures, which form a part hereof. It should be understood, however, that the arrangements described herein are set forth as examples only. As such, those skilled in the art will appreciate that other arrangements and elements (e.g., machines, interfaces, functions, orders of functions, etc.) can be used instead or in addition. Further, many of the elements described herein are functional entities that may be implemented as discrete or distributed components or in conjunction with other components, and in any suitable combination and location. Various functions described herein as being performed by one or more entities may be carried out by hardware, firmware and/or software logic. For instance, various functions described herein may be carried out by a processor executing instructions written in any suitable programming language and stored in memory.

For purposes of illustration, the systems and methods described herein focus on a home healthcare setting. However, other possibilities are also possible, such as hospice. The systems and methods described herein allow care providers and organizations that serve patients to enter time for an activity into a system, and have the system round the time to remove gaps and/or account for slight variations between visit start times, visit end times, durations spent serving patients, distance traveled to serve patients, etc. For example, a care event, such as a patient visit, may be scheduled to start at 9:00 am. The care provider may arrive at 8:57 am, i.e., a couple of minutes early. Rather than wait until 9:00 am to begin providing care to the patient, the care provider may begin care at 8:57 am. The systems and methods may determine that the care provider started a couple of minutes early, and round the care event start time to the scheduled start time, i.e., 9:00 am. If the care provider were to finish a couple of minutes early, the systems and methods would similarly account for this by rounding the actual end time to the scheduled end time. The parameters on if, and when, an actual time value (such as an actual start time or an actual end time) can be rounded to a scheduled time value (such as a scheduled start time or a scheduled end time) may be based on one or more threshold ranges. By allowing actual time values to be rounded to scheduled time values, the systems and methods beneficially help to keep records clean for reporting purposes and limit the number of unaccounted gaps that may occur throughout the day. Should the care provider vary too much from the scheduled start time and/or scheduled end time, the systems and methods may provide for a lockdown that may prevent the care event from being billed to United States or Canadian Medicare, Medicaid, and/or private pay.

Additional features are also available using the systems and methods described herein. For instance, rather than round a care event based on a scheduled start time and/or a scheduled end time, the systems and methods may provide rounding mechanisms based on the scheduled duration of the care event (e.g., the amount of time that the care event is schedule to take), and the actual duration of the care event (e.g., the actual amount of time taken to complete the care event). If the actual duration is within the threshold range of the scheduled duration, the systems and methods may round an actual start time to a calculated start time, wherein the calculated start time may be determined by subtracting the scheduled duration from the actual end time. A similar approach may be taken to round an actual end time to a calculated end time, where the actual start time plus the actual scheduled duration may be used to determine the actual end time. For example, if a care provider is scheduled to perform a care event for 30 minutes, but it only takes the care provider 28 minutes to perform the care event, the systems and methods may determine whether the two minute difference between the actual duration and the scheduled duration is within a threshold. If so, the systems and methods may allow the entire 30 minutes to be recorded rather than the 28 minutes. For computing and recording purposes, the systems and methods may account for the two minute difference by rounding the actual start time to 30 minutes before the actual end time, or by rounding the actual end time to 30 minutes after the actual start time. This allows for a useful record having fewer gaps throughout the day. Should problems arise in the record, such as the care provider spending too much or too little time caring for a patient, the systems and methods may notify the care provider of the problem. Further, locking mechanisms may be put in place to prevent submission of time where the actual duration exceeds or falls short of the scheduled duration, thereby limiting the number of erroneous care event entries that are submitted for reimbursement.

Additional features may exist to round an actual amount of time and/or distance that occurs between visits to a calculated time and/or distance between visits. For example, after a first care event ends, the care provider will often start a second care event. When providing care in a nursing home, for example, this may require the care provider to go down the hall from a first patient's room to a second patient's room. However, when providing in-home care, the care provider may need to drive or otherwise get from the first patient's home to the second patient's home. The amount of time between the actual end time associated with the first patient and the actual start time associated with the second patient may be representative of a calculated travel time or time between visits. But the time between visits may not always be representative of the amount of time it actually takes the care provider to travel from the first patient to the second patient. Rather, events may occur between visits, such as the care provider running an errand or taking a lunch break, which may not be reimbursable. Other examples also exist.

Various steps may be taken to avoid employers or other paying entities from getting reimbursed for time and/or distance traveled that is not related to a care event. For example, the systems and methods may obtain actual travel times (such as times entered by the care provider, times received from location services including Internet mapping services, and/or times obtained from GPS services) and compare the actual travel times to the time between visits. If the actual travel time is within a threshold range of the time between visits, the systems and methods may allow the actual travel time to be rounded to the time between visits. If the actual travel time is outside of the threshold range, the systems and methods may lock the care event entry or the travel time between visits entry. By locking travel time that may not be reimbursable, the employer or paying entity may avoid improper reimbursement.

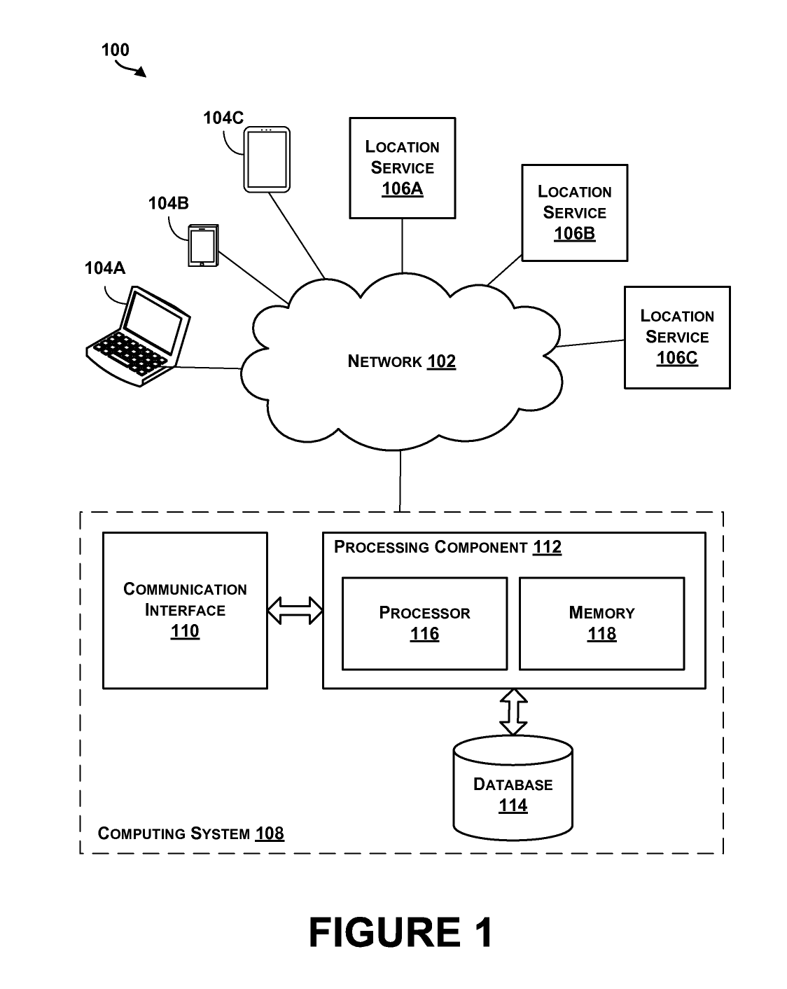

Referring now to the figures, FIG. 1 is simplified block diagram that illustrates a system 100 in which embodiments of the disclosed methods and entities can be implemented. System 100 includes a network 102 that facilitates communication between a communication device (such as communication devices 104A-C), services (such as location services 106A-C), and/or a computing system (such as computing system 108). Network 102 may take a variety of forms and provide connectivity with one or more transport networks, such as the Internet.

Communication devices 104A-C may include any number of devices that are configured to communicate according to an agreed communication protocol. Example communication devices 104A-C may include stationary or mobile computing devices such as a personal computer, laptop computer, tablet computer, cellular telephone, smartphone, personal digital assistant (PDA), personal navigation device (PND), or other computing device now known or later developed. In addition to being configured to communicate with the network 102, communication devices 104A-C may be further configured to communicate with each other and/or location services 106A-C.

Location services 106A-C may include a number of devices and/or services that are configured to obtain and/or provide location data. Example location services 106A-C may include global positioning systems (GPS) as well as services that are configured to provide map data, travel distance data, and/or travel time data to communication devices 104A-C and/or computing system 108. Other examples are also possible. Although FIG. 1 illustrates location services 106A-C as separate services, it should be understood that one or more location services 106A-C may be combined with one another and/or may be integrated with communication devices 104A-C. For example, communication device 104A may include location services 106A-C such as a GPS service that provides travel distance data and travel time data to the communication device 104A.

Computing system 108 may be configured to send and receive data from communication devices 104A-C and location services 106A-C via network 102. Computing system 108 may include a communication interface 110, a processing component 112, a database 114, as well as any number of additional features to facilitate operation of the systems and methods described herein. Communication interface 110, processing component 112, and database 114 may be communicatively linked by a system bus, network, or other connection mechanism.

Communication interface 110 may enable a user to provide and receive data using communication devices 104A-C. The data may encompass a variety of fields describing data associated with a care event. The data associated with the care event may include, for example, patient vitals, medications, dosages, as well as a time that the care event started, a time that the care event ended, a duration of the care event, a distance traveled to the care event location, an amount of time to travel to the care event location, a distance traveled from a first care event location to a second care event location, an amount of time to travel from the first care event location to the second care event location, etc. Communication interface 110 may receive the data input and provide output to communication devices 104A-C. In some instances, the output may be in the form of a web page or other graphical user interface that may be transmitted via the Internet and viewed by a user using a web browser program.

Communication interface 110 may be communicatively coupled to the processing component 112. As shown in FIG. 1, the processing component 112 may include a processor 116 and a memory 118. Processor 116 may be any type of processor, such as a microprocessor, digital signal processor (DSP), multicore processor, etc., coupled to memory 118. Memory 118 may be any suitable type of memory, such as volatile memory like random access memory (RAM), dynamic random access memory (DRAM), static random access memory (SRAM), or non-volatile memory like read-only memory (ROM), flash memory, magnetic or optical disks, or compact-disc read-only memory (CD-ROM), among other devices used to store data or programs on a temporary or permanent basis. In other instances, processing component 112 may include multiple processors and/or memories. Similarly, computing system 108 may include multiple processing components. Processor 116 may be configured to execute program instructions stored in memory 118 to provide one or more functionalities.

Processing component 112 may also be coupled to database 114. While only one database is illustrated, database 114 may include multiple databases for multiple purposes. In one example, database 114 may be used to store care event data, such as patient data, care provider data, start and end time data, duration data, location data, travel data, etc. Other examples are also possible.

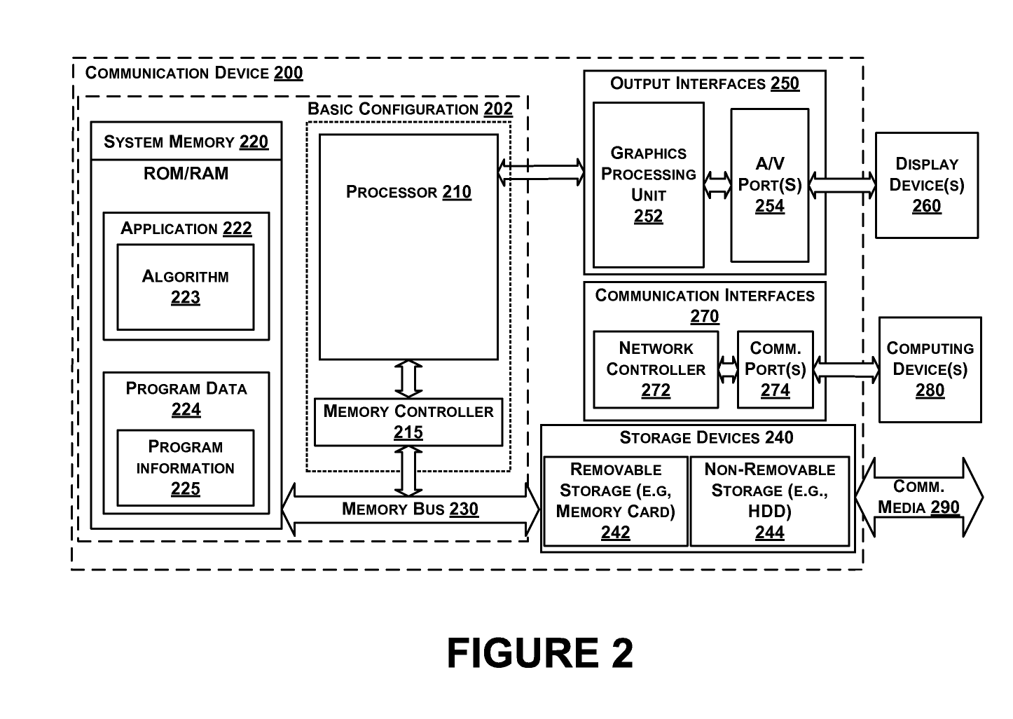

FIG. 2 is a functional block diagram that illustrates a communication device 200 used in a computing system in accordance with at least some of the embodiments described herein. Communication device 200 may be representative of communication device 104A-C of FIG. 1. In a basic configuration 202, communication device 200 may include one or more processors 210 and system memory 220. A memory bus 230 can be used for communicating between the processor 210 and the system memory 220. Depending on the desired configuration, processor 210 can be a microprocessor (μP), a microcontroller (μC), a digital signal processor (DSP), or any combination thereof. A memory controller 215 can also be used with the processor 210, or in some implementations, the memory controller 215 can be an internal part of the processor 210.

Depending on the desired configuration, the system memory 220 can be of any type, including volatile memory (such as RAM), non-volatile memory (such as ROM, flash memory, etc.), or any combination thereof. System memory 220 may include one or more applications 222 and program data 224. Application 222 may include an algorithm 223 that is arranged to provide inputs to the electronic circuits, in accordance with the present disclosure. Program data 224 may include program information 225 that could be directed to various data types. For instance, application 220 may execute one or more algorithms that may be configured to perform activity rounding and lockdown associated with one or more care events. In some example embodiments, application 222 can be arranged to operate with program data 224 on an operating system (not shown).

Communication device 200 can have additional features or functionality, and additional interfaces to facilitate communications between the basic configuration 202 and any devices and interfaces. For example, data storage devices 240 can be provided including removable storage devices 242, non-removable storage devices 244, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), memory cards, and tape drives to name a few. Computer storage media can include volatile and nonvolatile, transitory, non-transitory, removable and non-removable media implemented in any method or technology for storage of information, such as computer readable instructions, data structures, program modules, or other data.

System memory 220 and storage devices 240 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by communication device 200. Any such computer storage media (or others) can be part of device 200.

Communication device 200 can also include output interfaces 250 that may include a graphics processing unit 252, which can be configured to communicate with various external devices such as display devices 260 or speakers via one or more A/V ports 254 or a communication interfaces 270. The communication interfaces 270 may include a network controller 272, which can be arranged to facilitate communications with one or more computing devices 280 over a network via one or more communication ports 274. In some examples, communication interface 270 may communicate directly or indirectly with communication interface 110 of the computing system 108 (as illustrated in FIG. 1). A communication connection is one example of a communication medium. Communication media 290 may be embodied by computer readable instructions, data structures, program modules, or other data in a modulated data signal, such as a carrier wave or other transport mechanism. The communication media 290 may also include wireless, optical, or other information delivery media. A modulated data signal can be a signal that has one or more of its characteristics set or changed in such a manner to encode information in the signal. By way of example, and not limitation, communication media 290 can include wired media such as a wired network or direct-wired connection, and wireless media such as acoustic, radio frequency (RF), infrared (IR) and other wireless media. The communication may optionally or additionally include a cellular or cellular data connection, a satellite data connection, etc.

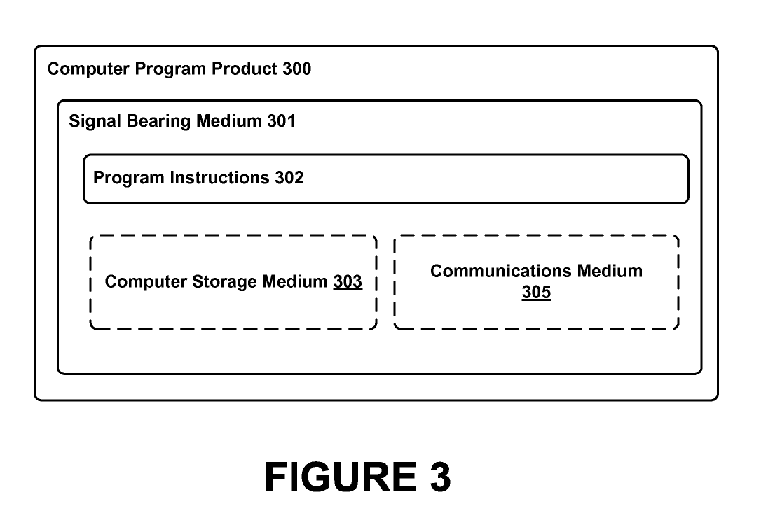

In some embodiments, the disclosed methods may be implemented as computer program instructions encoded on a non-transitory computer-readable storage media in a machine-readable format, or on other non-transitory media or articles of manufacture. FIG. 3 is a schematic diagram that illustrates a conceptual partial view of an example computer program product 300 that includes a computer program for executing a computer process on a communication device, arranged according to at least some embodiments presented herein.

In one embodiment, example computer program product 300 may be provided using a signal bearing medium 301. Signal bearing medium 301 may include one or more programming instructions 302 that, when executed by one or more processors, may provide functionality or portions of the functionality described with respect to the systems and methods described herein.

In some examples, signal bearing medium 301 may encompass a computer storage medium 303, such as, but not limited to, a hard disk drive, a Compact Disc (CD), a Digital Video Disk (DVD), a digital tape, memory, etc. In some instances, the computer-readable medium may include a non-transitory computer readable medium, for example, such as computer-readable media that stores data for short periods of time like solid state memory, flash drives, register memory, processor cache and Random Access Memory (RAM). The computer-readable medium may also or alternatively include non-transitory media, such as secondary or persistent long term storage, like read only memory (ROM), optical or magnetic disks, compact-disc read only memory (CD-ROM), for example. The computer-readable media may also be any other volatile or non-volatile storage system. The computer readable medium may, for example, be considered a computer readable storage medium or a tangible storage device.

In some implementations, signal bearing medium 301 may encompass a communications medium 305, such as, but not limited to, a digital and/or an analog communication medium (e.g., a fiber optic cable, a waveguide, a wired communications link, a wireless communication link, etc.). Thus, for example, signal bearing medium 301 may be conveyed by a wireless form of communications medium 305 (e.g., a wireless communications medium conforming with the IEEE 802.11 standard or other transmission protocol).

The one or more programming instructions 302 may be, for example, computer executable and/or logic implemented instructions. In some examples, a communication device such as communication devices 104A-C of FIG. 1 may be configured to provide various operations, functions, or actions in response to programming instructions 302 conveyed to communication device 300 by one or more of the computer storage medium 303, and/or the communications medium 305. In some examples, the programming instructions 302 may be provided or otherwise obtainable in a downloadable format, such as via an application store for a portable device.

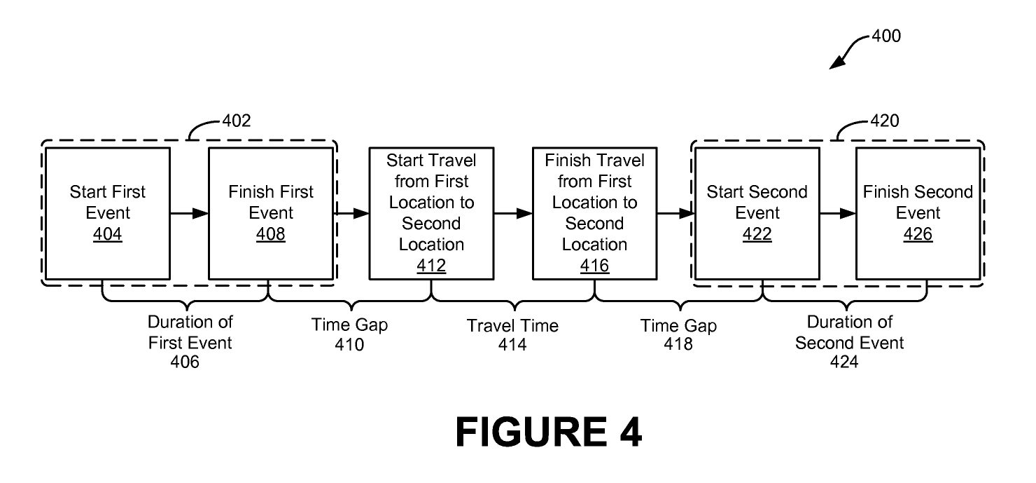

FIG. 4 is a simplified block diagram that illustrates a timeline 400 of events in accordance with embodiments described herein. The illustrated timeline 400 may be representative of events performed by a care provider during a period of time, such as a morning, afternoon, day, week, month, etc. The type of events performed by the care provider may vary between patient, ailment, type of coverage available to the patient, etc. Example events may include care events, such as a first care event 402 and a second care event 420. Care events may include administering medication to a patient, bathing a patient, and taking a patient's blood pressure. Other examples are also possible. Care events may be specific to a patient or common to a plurality of patients.

The timeline 400 begins at block 404 when a first care event 402 is started. The start time of the first care event 402 may be determined or otherwise identified in a number of ways. For example, a user (such as a care provider, administrator, or other entity capable of providing data directly or indirectly to a computing server, such as computing server 108 in FIG. 1) may enter the start time of the first care event 402 into a communication device (such as communication device 200 in FIG. 2). In another example, the user may perform an action that causes the communication device to obtain a current time and use the current time as the start time. For instance, the user may select a begin indicator on the communication device, which may cause the communication device to identify the care event start time as the time at which indicator was selected. Another instance may include the user entering data, which the communication may use to determine that a care event has started and accordingly associate the time at which the data was selected as the care event start time. In yet another example, the communication device may use GPS or other data to determine when the care provider arrives at the location of the first care event 402 (e.g., a first care event location), and identify the arrival time as the time at which the first care event 402 is started. Other examples are also possible, some of which may allow the time to be determined or otherwise identified after the first care event 402 has started or finished.

The timeline 400 continues at block 408 when the first care event 402 is finished. There are a number of ways to determine that the first care event 402 is finished. For example, the user may enter data into the communication device indicating that the first care event 402 is complete, that the first care event 402 has been paused and may be resumed at a later time, or that the first care event 402 is otherwise finished for billing purposes, etc. The process of entering the data into the communication device may include the user entering the time at which the first care event 402 is finished. Optionally, the time at which the first care event 402 is finished may be determined and entered by the communication device in response to an input. Examples of inputs may include the user selecting a finish indicator or the communication device calculating a change in GPS location and deducing that the first care event 402 has ended. Other examples also exist that determine or identify the time that the first care event 402 is finished. The duration between the time at which the first care event 402 is started (e.g., block 404) and the first care event 402 is finished (e.g., block 408) may be representative of a duration of time 406 to complete the first care event 402.

At block 412, the timeline 400 may include starting travel from the first care event location to a second care event location. The first care event location may be associated with the location at which the first care event 402 took place or was scheduled to take place. Likewise, the second care event location may be associated with the location at which a second care event is scheduled to take place. The time that the travel starts may be identified or otherwise determined based on data entered by the user or based on data (such as GPS data, travel distance, etc.) obtained by the computing system either directly or indirectly from the communication device or a service (such as a location service). There may be a time gap 410 between the time that the first event is finished (e.g., block 408) and the time that the care provider starts to travel from the location of the first care event 402 to the location of the second care event (e.g., block 412).

The timeline 400 may further include, at block 416, finishing travel from first care event location to second care event location. The time at which travel from the first location to the second location finishes may be identified or otherwise determined based on data entered by the user or based on data (such as GPS data, travel distance, etc.) obtained by the computing system either directly or indirectly from the communication device or a service (such as a location service). The time between when the user starts to travel to the second care event location (e.g., block 412) and when the user finishes traveling to the second care event location (e.g., block 416) may be representative of a travel time 414.

At block 422, the timeline 400 may include starting second care event 420. The second care event 420 may be representative of a care event that is associated with a different patient, service, billable care event, etc. For example, the second care event 420 may be for the same patient as the first care event 402, but might include a different service that may or may not be separately reimbursable. In another example, the second care event 420 may be for a second patient; however, the actual care event performed on the second patient might be the same care event that was performed on the first patient. This can occur, for example, if the first and second patients both receive kidney dialysis treatments. Other examples are also possible. The process of determining when the second care event 420 starts may be similar, but not limited to, the process described above in reference to block 404. In some instances, there might be a time gap 418 between the time that the user arrives at the location of the second care event (e.g., block 416) and the time that the second care event begins (e.g., block 422).

At block 426, the timeline 400 may include finishing the second care event 420. As described in more detail in reference to block 408, the care event (such as the second care event 420) may finish at a variety of times including, but not limited to, the completion of the care event, the pausing of a care event, the end of a billable portion of work involved in an overall care plan, etc. A time at which the second care event 420 occurs may be identified or otherwise determined based on data entered by the user or deduced directly or indirectly by the communication device or computing system. The duration between the time at which the second care event is started (e.g., block 422) and the second care event is ended (e.g., block 426) may be representative of a duration of time 424 to complete the second care event 420.

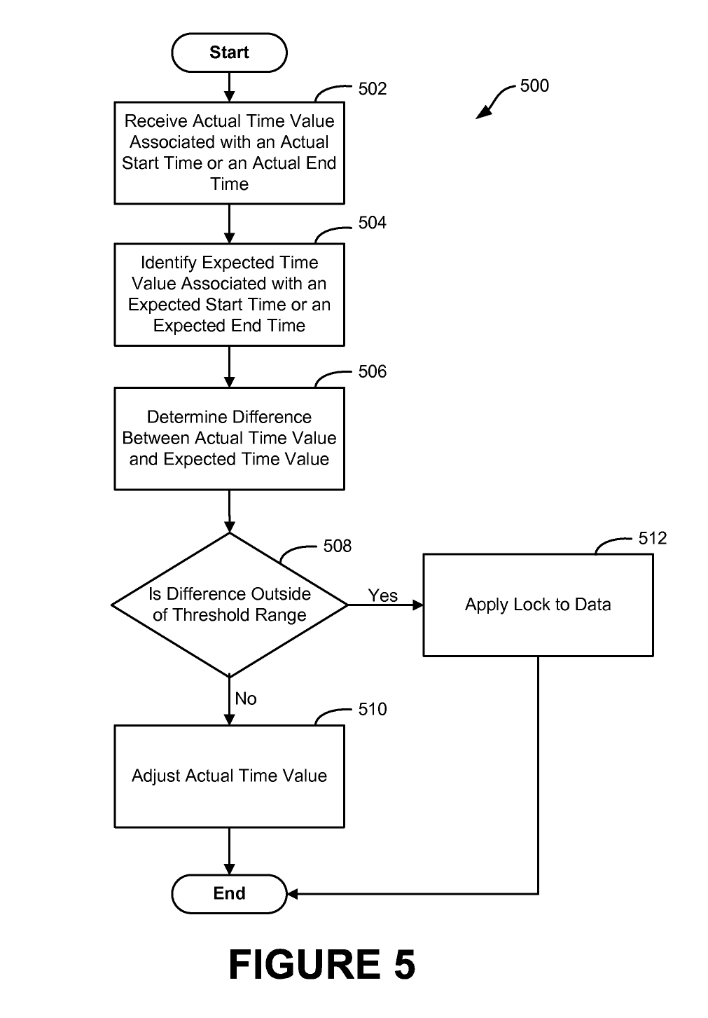

FIGS. 5-7 are flow diagrams 500, 600, and 700 that depict functions that may be included in the computing system to facilitate implementation of the methods described herein. The methods may be used with the system 100, and may be performed by a device or components of one or more devices. An example device may include the computing system in FIG. 1, the communication device in FIG. 2, or any number or combination of other devices associated with the system. The methods may include one or more operations, functions, or actions as illustrated by one or more of the flow-diagram blocks described herein. Although the blocks are illustrated in a sequential order, these blocks may also be performed in parallel and/or in a different order than those described herein. Also, the various blocks may be combined into fewer blocks, divided into additional blocks, and/or removed based upon the desired implementation.

In addition, it should be understood that the flow diagrams show functionality and operation of possible implementations of the present embodiments, though other implementations are also possible. Each block in the flow diagrams may represent a module, a segment, or a portion of program code that includes one or more instructions executable by a processor for implementing specific logical functions or steps in the process. The program code may be stored on any type of computer readable medium, such as computer storage medium 303 in FIG. 3. For purposes of illustration, the methods in FIGS. 5-7 are described as being implemented by a computing system; however, other possibilities are also possible.

Referring to FIG. 5, the flow diagram depicts a method 500. The method 500 may begin at block 502, with the computing system receiving an actual time value. The actual time value may be represented in a variety of formats, such as standard time, military time, or other format that allows for a time to be represented electronically. The actual time value may be a timestamp, for example. In some examples, the time format may also include a date. The actual time value may be associated with an actual start time or an actual end time of a care event. The actual start time may represent a time at which a care provider begins the care event. In contrast, the actual end time may represent a time at which the care provider finishes the care event. The actual time value may be entered by a user (such as a care provider) or determined using information obtainable by a communication device (such as GPS location data). The actual time value may be sent directly or indirectly to the computing system.

At block 504, the method 500 may include identifying an expected time value. The expected time value may be associated with an expected start time or an expected end time. The expected start time may represent a time at which a care event is scheduled to begin, whereas the expected end time may represent a time at which a care event is scheduled to end. The expected time value may be represented in the same or different format than the actual time value. When represented in different formats, the expected time value and/or the actual time value may be converted into a different format that may allow the expected time value to be compared to the actual time value.

The process of identifying an expected time value may vary. For example, the process may include the system identifying the care provider, receiving a patient identifier or otherwise identifying a patient (e.g., by a GPS location or other indicator), and determining a time at which the care event for the care provider or patient is scheduled to begin. In another example, the process may include the computing system identifying a care provider, determining one or more care events that the care provider is scheduled to perform during a reporting period (e.g., such as a period extending over the course of a number of minutes, hours, days, weeks, months, etc.), determining one or more care event(s) that are scheduled at a time proximate to the actual time value, identifying at least one of the one or more care event(s) as a candidate care event that is likely to be performed, and determining a time at which the candidate care event is scheduled to begin. Other examples also exist.

At block 506, the method 500 may include determining a difference between an actual time value and an expected time value. The determination may be performed by subtracting the expected time value from the actual time value, although subtraction of the actual time value from the expected time value is also possible. In some examples, a data conversion may be applied to facilitate the subtraction. This conversion may allow, for example, time data represented in standard time to be compared to time data represented in military time. Other examples are also possible. Moreover, while subtraction is described herein, it should be understood that any number of algorithms may be implemented to compare the actual time value to the expected time value.

At block 508, the method 500 may include determining if the difference between the actual time value and the expected time value is outside of a threshold range. The threshold range may take a variety of forms. For example, the threshold range may be a calculated range based on one or more data inputs, patient details, care event details, user preferences, client preferences, etc. For instance, the threshold range may be based on a percentage of time that the care event is scheduled to last. Thus, the threshold range for a care event scheduled for 60 minutes may be larger than the threshold range for a care event scheduled for 30 minutes. The threshold range may also take the form of a predefined range that may be defined by a user, patient, United States or Canadian Medicare, Medicaid, and/or private pay. For instance, practices and procedures for a company may dictate that the threshold range can be no more than five minutes. In another instance, the client may specify that a threshold range should not be used (e.g., that only actual times should be reported or otherwise used for reimbursement purposes). The systems and methods described herein provide for conflict resolution procedures in the event of a conflict in the threshold range.

At block 510, the method 500 includes adjusting the actual time value. Adjusting the actual time value may include more than rounding to the nearest second or minute for purposes of standardizing units. For example, adjusting the actual time value may include (i) adjusting the actual start time value to the scheduled start time value, or (ii) adjusting the actual end time value to the scheduled end time value. For example, if a care event is scheduled to start at 2:15 pm, but the actual time at which the care event begins is 2:20 pm, the computing system may determine that the five minute difference between the actual start time and the scheduled start time is within a threshold range, and accordingly adjust or otherwise round the 2:20 pm actual start time to the 2:15 pm scheduled start time. This may help to remove time gaps, account for otherwise unrecorded time, and/or make time entry more efficient. It should be understood that adjustments performed using the systems and methods described herein may be stored in a database or other construct. In some examples, the adjustments may overwrite the actual data. In other examples, however, the actual data may be stored in addition to the adjustments.

In the event that the difference between the actual time value and the expected time value is outside of the threshold range, the method 500 may include, at block 512, applying a lock to the data. When applied, the lock may be applied to all of the data associated with a care event or a portion thereof. For example, the lock may be applied to the performance of the care event, but may not be applied for purposes of reimbursing the time to get to the location of the care event or the distance traveled to get to the location of the care event. Once a lock is applied, the data associated with the lock may not be sent for reimbursement without authorization. The authorization may vary between implementations. In one implementation, the authorization may be a click-through authorization, while another authorization may require confirmation from the patient that the care provider was present during the time that was submitted. In yet another implementation, authorization from United States or Canadian Medicare, Medicaid, or private pay may be required before unlocking the data for reimbursement purposes.

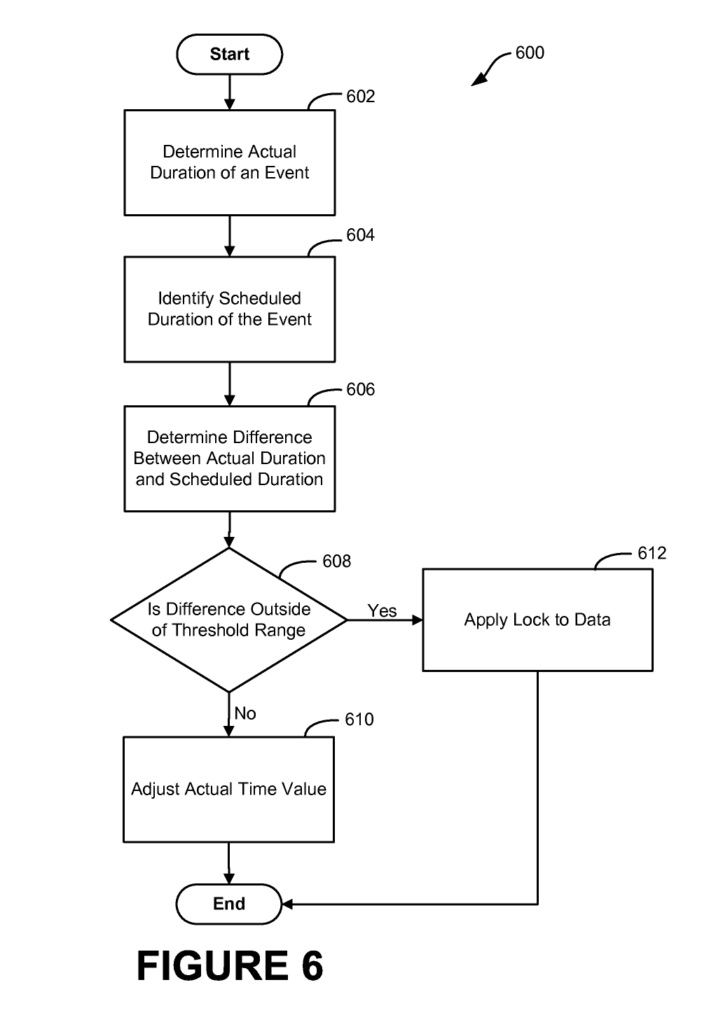

Referring now to FIG. 6, the flow diagram depicts a method 600 that begins at block 602 with the computing system determining an actual duration of a care event. The actual duration of the care event may be determined in a number of ways. For example, the actual duration may be determined based on the difference between an actual care event start time and an actual care event end time. The process of identifying or otherwise determining the actual care event start time and the actual care event end time may be similar to those described above in reference to FIG. 5.

At block 604, the method 600 may include identifying a scheduled duration of a care event. The scheduled duration may be a predetermined value stored in a database (such as database 114) or may be based on the difference between the scheduled care event start time and the scheduled care event end time. One or both of the scheduled care event start time and the scheduled care event end time may be stored in a database or otherwise obtained using one or more queries. In some examples, the scheduled care event may be associated with an average or expected time that the care event should take. This time may be used to determine the scheduled duration.

At block 606, the method 600 may include determining a difference between the actual care event duration and the scheduled care event duration. This determination may be performed, for example, by subtracting the actual care event duration from the scheduled care event duration (or vice versa) to determine a difference. In some examples, a data conversion may be applied to facilitate the subtraction. This conversion may allow, for example, time data represented in standard time to be compared to time data represented in military time. Other examples are also possible. Moreover, while subtraction is described herein, it should be understood that any number of algorithms may be implemented to compare the actual duration to the expected duration.

At block 608, the method 600 may include determining if the difference between the actual duration and the expected duration is outside of a threshold range. The threshold range may take a variety of forms. For example, the threshold range may be a calculated range based on one or more data inputs, patient details, care event details, user preferences, client preferences, etc. For instance, the threshold range may be based on a percentage of the scheduled duration of the care event. The threshold range may also take the form of a predefined range that may be defined by a user, patient, United States or Canadian Medicare, Medicaid, and/or private pay. In another instance, the client may specify that a threshold range should not be used. The systems and methods described herein provide for conflict resolution procedures in the event of a conflict in the threshold range.

At block 610, the method 600 includes adjusting the actual time value associated with the care event. The actual time value may include (i) the actual start time value associated with the care event, or (ii) the actual end time value associated with the care event, for example. The process of adjusting or rounding the actual start time value associated with the care event to a calculated start time value may include subtracting the scheduled duration from the actual end time value; however, other examples are also possible. For example, suppose that the actual start time of a care event is 10:10 am, the actual end time of the care event is 10:44 am, and the scheduled duration is 30 minutes. The actual duration of the care event (as determined from the actual start time and the actual end time) is 34 minutes. The difference between the actual duration of 34 minutes and the scheduled duration of 30 minutes is four minutes. Rather than record 34 minutes, the computing system may round the actual start time of the event from 10:10 am (i.e., from the actual start time of the care event) to 10:14 am (i.e., 10:44 am minus the scheduled 30 minute duration of the care event).

In another example, the computing system may round the actual end time value associated with the care event to a calculated end time value, which may include adding the scheduled duration to the actual start time value. Consider the example where the actual start time of a care event is 1:02 pm, the actual end time of the care event is 1:59 pm, and the scheduled duration is 60 minutes. The difference between the actual duration of 57 minutes and the scheduled duration of 60 minutes is three minutes. Rather than record 57 minutes, the computing system may round the actual end time of the event from 1:59 (i.e., from the actual end time of the care event) to 2:02 pm (i.e., 1:02 pm plus the scheduled 60 minute duration of the care event). This allows the actual time value to be recorded in a way that can facilitate efficient recording of time for reimbursement purposes.

Should the difference between the actual duration of the care event and the scheduled duration of the care event may be outside of the threshold range, the method 600 may include, at block 612, applying a lock to the data. The lock may be applied to all of the data associated with a care event or a portion thereof. Once applied, the lock would make data associated with the care event ineligible for export (and reimbursement) until the lock is removed. In the event of multiple locks being applied to all or part of the care event data, all or a defined subset of the locks may be removed before the data is eligible for export for reimbursement purposes.

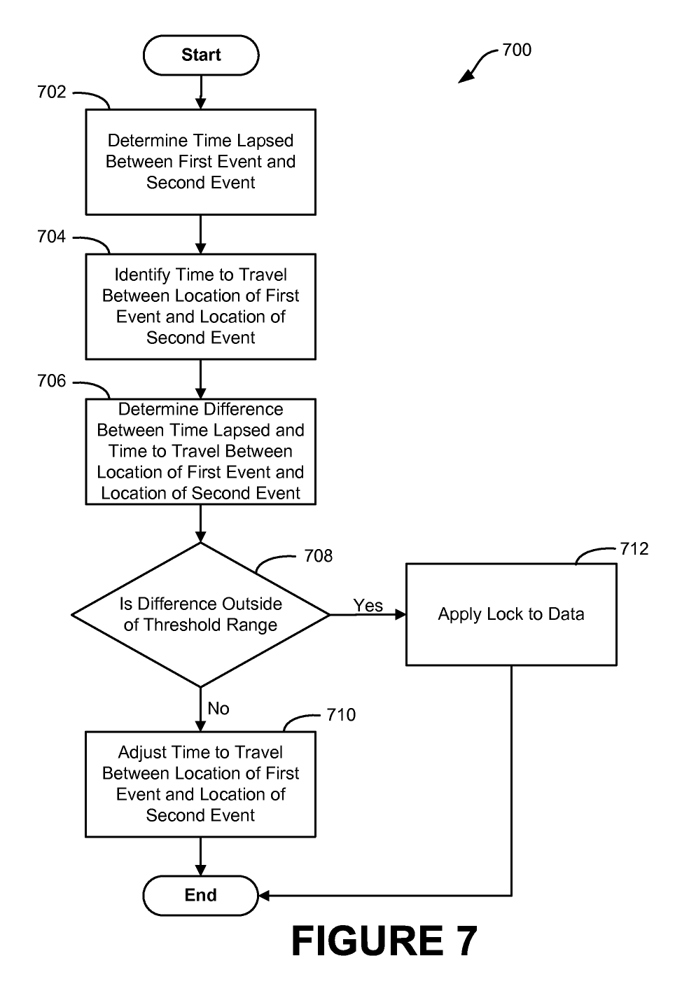

Referring now to FIG. 7, the method 700 may include, at block 702, determining a time that has lapsed between a first care event and a second care event. The time lapsed may be indicative of a time between visits. A number of processes may be used to determine the time between visits. Example processes may include subtracting the actual (or scheduled) time that the first care event ended from an actual (or scheduled) time that the second care event begins. Another example process may allow a user to enter the time between when the first care event ends and the second care event begins.

At block 704, the method 700 may include identifying a time to travel between a location of the first care event and a location of the second care event. The identified time to travel between locations may be indicative of an export travel time. The export travel time can be determined in a variety of ways. For example, the user can enter the export travel time. In another example, the computing system may determine the export travel time based on previously entered data, GPS data, time data from a mapping service, on-board monitors in a transportation mechanism that may identify start and stop times, a timer associated with a communication device or the computing system, time data stored or received by the computing system, etc.

At block 706, the method 700 may include determining a difference between the time lapsed and the time to travel between the first care event location and the second care event location. Although the time between visits is described in terms of subtraction, other methods may additionally or alternatively be used to determine differences between the time between visits and the export travel time.

At block 708, the method 700 may include determining if the difference is outside of a threshold range. The threshold range may take a variety of forms. For example, the threshold range may be a calculated range based on one or more data inputs, patient details, care event details, user preferences, client preferences, etc. For instance, the threshold range may be based on a percentage of the scheduled time to travel between the location of the first care event and the location of the second care event. The threshold range may also take the form of a predefined range that may be defined by a user, patient, United States or Canadian Medicare, Medicaid, and/or private pay. In another instance, the client (e.g., patient, paying entity, etc.) may specify that a threshold range should not be used. The systems and methods described herein provide for conflict resolution procedures in the event of a conflict in the threshold range.

At block 710, the method 700 includes adjusting the time to travel between the location of the first event and the location of the second event. The process of adjusting the time may include the computing system rounding the export travel time (i.e., the time to travel between the location of the first care event and the location of the second care event of block 704) to the time between visits (i.e., the time that has lapsed between the first care event and the second care event of block 702). For example, a user may complete a care event at the first location at 11:00 am and begin traveling to a second location to perform another care event. The user may arrive and begin working with a patient at the second location at 11:13 am. The time between visits may be calculated as being 13 minutes (i.e., the difference between the actual start time of the care event at the second location and the actual end time of the care event at the first location).

The export travel time may be the same or different from the time between visits. For instance, the export travel time and time between visits may be the same when the user travels directly from the first location to the second location—without stops or performing other activities. The export travel time and time between visits may vary, however, when the user performs tasks between the visits. For example, the export travel time and the time between visits may be different when a user (such as a care provider) takes time to finish entering patient data for the patient at the first location before traveling to the second location. In another example, the user may eat lunch after leaving the first location, but before arriving at the second location. The time to enter the data or to eat lunch may be included in the time between visits, but may not be included in the export travel time. Thus, while the time between visits may be 13 minutes, the export travel time may only be 10 minutes. For record keeping and reimbursement purposes, the computing device may round the 10 minute export travel time to the 13 minute time between visits; thereby removing the 3 minute gap between the time between visits and the export travel time.

At block 712, the method 700 may include applying a lock to the data. The lock may be applied, for example, when the difference between the export travel time and the time between visits falls outside of the threshold range. The lock may be applied to all of the data associated with a care event or a portion thereof. Once applied, the lock would make data associated with the care event ineligible for export (and reimbursement) until the lock is removed. In the event of multiple locks being applied to all or part of the care event data, all or a defined subset of the locks may be removed before the data may be eligible for export for reimbursement purposes.

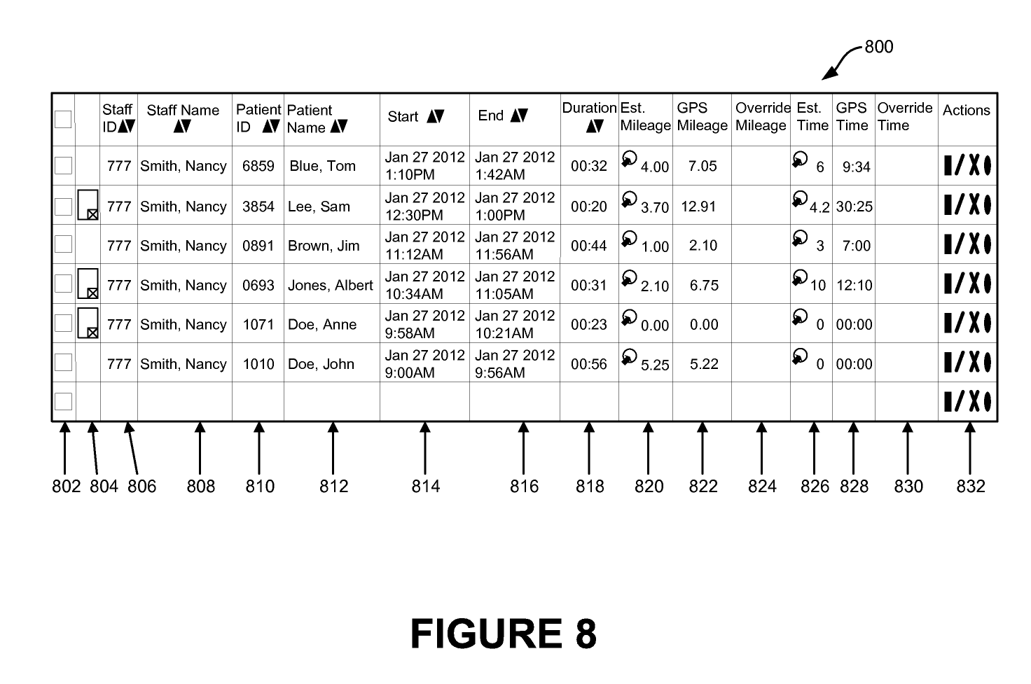

FIG. 8 is a pictorial diagram that illustrates a user interface view 800 associated with one or more care visits, in accordance with embodiments described herein. The user interface view 800 may be accessed by a variety of users including a care provider, employer, insurance provider, care plan administrator, etc. In some examples, the user interface view 800 may have more or less information than illustrated in FIG. 8. The amount of information displayed or otherwise available to the user via the user interface view 800 may be based on user permissions that may restrict data access. The permissions may be determined by United States or Canadian Medicare, Medicaid, private pay, the patient, the care provider's employer, legislation, industry guidelines and/or best practices, etc.

The user interface view 800 of FIG. 8 includes a number of illustrative fields. The fields may include a selection field 802, which may allow a user to select one or more data entries. The fields may also include a lock indicator 804, which may provide the user with an indication that all or part of the data entry is locked. Also displayed via the interface may be a staff identifier 806, which may identify the staff member that is performing a task (such as a care visit). Example staff members may include a care provider or any other person that may track and enter time for internal purposes or for reimbursement purposes. The staff identifier 806 may be associated with a staff name 808. Other staff information is also possible. Patient information may also be illustrated via the user interface view 800. For example, a patient identifier 810 associated with the patient, a patient name 812, and/or other patient data may be available using the user interface view 800.

The user interface view 800 may also include an actual care event start time 814, actual care event end time 816, duration of care event 818, estimated distance 820 to (or from) the care event location, actual distance 822 to (or from) the care event location, a distance override indicator 224 that might indicate whether or not the distance was overridden, an estimated time 826 to travel to (or from) the care event location, a calculated amount of time 828 that it should take the care provider to travel to (or from) the care event location, a time override indicator 830 that might indicate whether or not the amount of time was overridden, one or more actions 832 that the user should or must take, etc. Examples of actions may include one or more steps that the user may perform based on inputs or calculations associated with the data entries, the creation of a report illustrating data available in the user interface view 800, an indication on whether data can be (or has been) edited, etc. Other data may also be displayed to the user.

Referring now to specific portions of FIG. 8, the lock indicator 804 may be representative of a lock being applied to all or part of a data entry. In some examples, the lock indicator 804 may be an alert that notifies a user that a lock has been applied. The lock may correspond to a validation rule that should or must be met before the data entry is exported. For example, a lock may be applied responsive to an alert condition being met. The alert condition may include: (i) a delayed start of a care event, (ii) a late finish of a care event, (iii) a care event that exceeds a determined duration of time, (iv) a care event that is less than a determined duration of time, (v) a short visit for a care event, (vi) a long visit for a care event, (vii) a missed visit for a care event, and/or (viii) other time or distance based events associated with a care event. For instance, in the example described above in reference to FIG. 5, a lock may be applied when the difference between an actual time value (such as an actual care event start time or an actual care event end time) and an expected time value (such as an estimated care event start time or an estimated care event end time) are outside of a threshold range. Further, as described in reference to FIG. 6, a lock may be applied when the difference between the actual duration of the care event and the scheduled duration of the care event falls outside of a threshold range.

In another instance, as described in reference to FIG. 7, a lock may be applied when the difference between the export travel time and the time between visits falls outside of a threshold range. This difference may be determined using various sources for the travel time including, but not limited to, a time obtained from a location service, a GPS service, a self-reported service, a time between visits, etc. For example, the difference may be a difference between a time provided from a location service and a calculated time between a first care event and a second care event. In another example, the difference may be a time between a location service and a GPS travel time. In yet another example, the difference may be a time between a GPS travel time and a self-reported travel time, which may be entered by the user. Other permutations and combinations are also possible. While described as separate calculations, it should be understood that multiple differences between the export travel time and the time between visits may be calculated and an average or weighted average of the differences may be determined and compared to a threshold range.

In yet another instance, a lock may be applied based on the travel distance associated with a care event. For example, a care provider may travel an actual distance 822 to (or from) a care event location. The actual distance 822 may represented in miles or kilometers. The actual distance 822 may be determined using a location service, a GPS service, self-reported distance, etc. A communication device, computing system, or other device, may determine a difference between the actual distance 822 and the estimated distance 820 and compare the difference to a threshold value. If the difference falls outside of the threshold value, a lock may be applied to all or part of the data associated with the care event. When a lock is applied, a lock indicator 804 may be provided to the user to indicate that all or part of an entry is locked.

There are a number of additional examples where a lock may be applied and a lock indicator 804 presented to a user. For example, the entity providing reimbursement for travel time and distance may set limitations as to how much time and/or distance is reimbursable in a given period (such as a day, week, month, year, etc.). Examples of entities that may set such limitations include, but are not limited to, United States or Canadian Medicare, Medicaid, private pay, the patient, the care provider's employer, or any reimbursement entity. In some examples, the amount of travel time may be a defined number for the entire period or a portion thereof. For instance, a care provider may be allowed a quota travel time each day, and report the total amount of travel time at the end of the week. A lock may be applied if the travel time for the day exceeds a threshold value and/or if the total travel time for the week exceeds the allowed travel time for the week. In another example, the amount of travel time may be calculated based on the locations of the care events during the period. This may allow the care provider more travel time when the care provider must travel farther distances between care event locations, and less travel time when the distance between care event locations is decreased. A lock may be applied when the travel time falls outside of the threshold range. The lock may be overridden by an authorized user (such as an employer, account representative, government official, patient, etc.) and an override time 830 may be displayed to indicate to the user that the time has been overridden. In some embodiments, the systems and methods described herein may employ optimization techniques for reducing the total travel time to save reimbursement expenses.

In yet another example, a lock indicator 804 may be presented to the user when the total distance traveled exceeds a threshold value. The total distance traveled may be determined by adding or otherwise combining all of the distances traveled during a period. United States or Canadian Medicare, Medicaid, private pay, the patient, the care provider's employer, or any reimbursement entity may define the amount of distance that is reimbursable during a period. Optionally, the amount of distance may be calculated based on distances between event locations scheduled or otherwise conducted during the period. Should the total distance traveled exceed the threshold value, all or part of a care event associated with the excess distance may be locked. For instance, if the total distance that is reimbursable is 100 miles (161 kilometers), and the actual distance traveled is 110 miles (177 kilometers), the care events associated with the excess care distance may be locked. Alternatively, the services performed while caring for the patient may be reimbursed, but not the travel distance in getting to (or from) the care event location. Other examples are also possible. The lock may be overridden by an authorized user, such as an employer, account representative, government official, patient, etc. An overridden distance may be displayed to the user via a distance override 824.

In some implementations, the user interface 800 may provide the user with details on what caused a lockdown, how to address the lockdown, who can override the lockdown, etc. For example, an automatic lockdown may be applied when erroneous data is entered into the system. Examples of erroneous data may include negative distances, negative travel times, start times that are later than end times, start and/or end times that are older than a specific date, etc. The user may be notified or otherwise alerted of the error and be provided with a way to fix the error before the data can be sent to an export queue for export to a communication device, computing device, etc. In some examples, the user may request a report for all or a portion of the data. The report may include data presentable via the user interface view 800, as well as one or more reasons for the lockdown. Other examples are also possible.

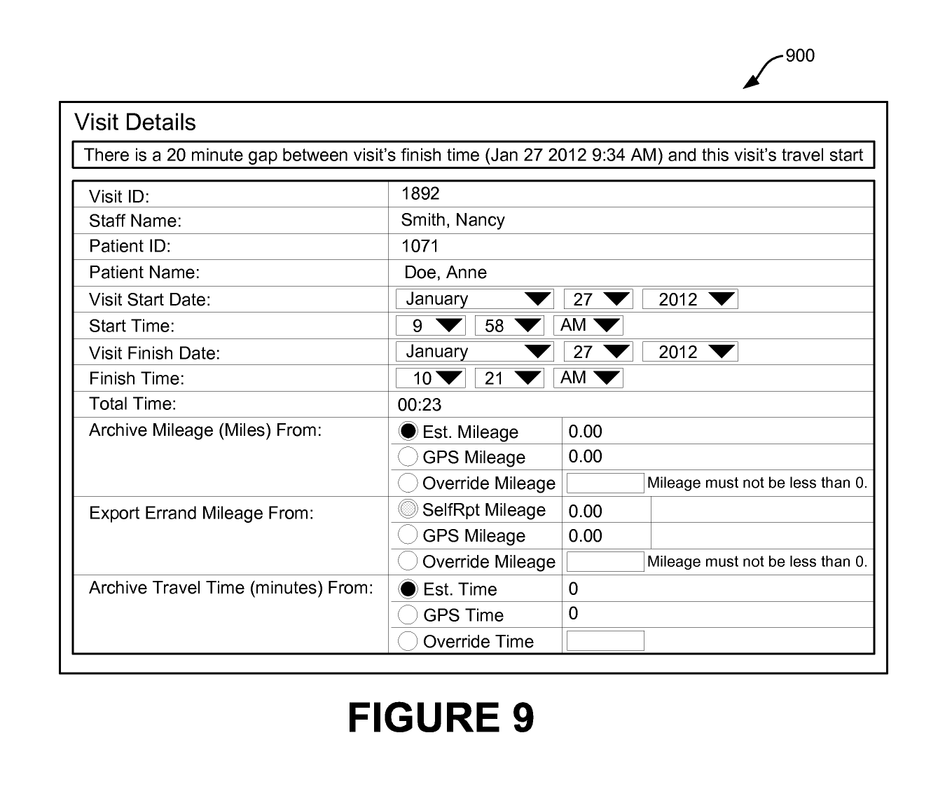

FIG. 9 is a pictorial diagram that illustrates a user interface view 900 associated with one or more care visits. The user interface view 900 allows an authorized user to modify data associated with a care event to un-lock the data. Whether, and to what extent, a user is authorized may be based on user credentials and/or permissions. For example, a care provider may be authorized to access his or her own submitted care event data and change all or part of the care event data that may have been entered in error. This may allow a user, for example, to edit an estimated distance between care events from 100 miles to 10 miles. In another example, an administrator may be authorized access to a plurality of care events to adjust or otherwise override the locked event. The lock override may occur responsive to data associated with a care event being changed to fall within a threshold range or by the user selecting to override the lock. Other examples are also possible.

In some examples, the user interface view 900 may provide the user with details on why a care event has been locked (e.g., because of a large time gap between care events). The user may interact with the user interface and correct the data to fall within one or more threshold ranges. In some examples, data entered using the user interface view may or may not be adjusted. For instance, if a user enters a time of 28 minutes using the user interface view 900, the 28 minutes may be stored and used rather than being rounded to 30 minutes for reimbursement purposes. This allows data that is entered using the user interface view 900 to remain as entered. Additional examples are also possible.

It should be understood that arrangements described herein are for purposes of example only. As such, those skilled in the art will appreciate that other arrangements and other elements (e.g. machines, interfaces, functions, orders, and groupings of functions, etc.) can be used instead, and some elements may be omitted altogether according to the desired results. Further, many of the elements that are described are functional entities that may be implemented as discrete or distributed components or in conjunction with other components, in any suitable combination and location.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims, along with the full scope of equivalents to which such claims are entitled. It is also to be understood that the terminology used herein is for the purpose of describing particular embodiments only, and is not intended to be limiting.

What is claimed is:

1. A method comprising:
receiving, by a computing device, data indicative of an actual time value associated with a care event;
identifying an expected time value associated with the care event;
determining that the difference between the actual time value associated with the care event and the expected time value associated with the care event is within a threshold range; and
based on the determination, processing the expected time value associated with the care event instead of the actual time value associated with the care event.

2. The method of claim 1, wherein receiving the data indicative of the actual time value associated with the care event further comprises receiving a start time indicative of a time at which the care event begins.

3. The method of claim 2, wherein identifying the expected time value associated with the care event further comprises identifying a time at which the care event is scheduled to begin.

4. The method of claim 1, wherein receiving the data indicative of the actual time value associated with the care event further comprises receiving a finish time indicative of a time at which the care event ends.

5. The method of claim 4, wherein identifying the expected time value associated with the care event further comprises identifying a time at which the care event is scheduled to end.

6. A method comprising:
determining an actual duration of time to perform a care event, wherein the actual duration is based on an actual start time and an actual end time;
identifying an expected duration of time to perform the care event, wherein the scheduled duration is based on an expected start time and an expected end time;
a computing device making a first determination that the difference between the actual duration of time to perform the care event and the expected duration of time to perform the care event is within a threshold range;
based on the first determination, the computing device adjusting at least one of the actual start time and the actual end time.

7. The method of claim 6, wherein adjusting at least one of the actual start time and the actual end time comprises adjusting the actual start time to a calculated start time, wherein the calculated start time is based on the difference between the actual end time and the expected duration.

8. The method of claim 6, wherein adjusting at least one of the actual start time and the actual end time comprises adjusting the actual end time to a calculated end time, wherein the calculated end time is based on the difference between the actual start time and the expected duration.

9. The method of claim 6, wherein the threshold range includes a lower threshold representative of a minimum number of minutes, and an upper threshold representative of a maximum number of minutes.

10. A method comprising:
receiving an end time value associated with a first care event at a first location;
receiving a start time value associated with a second care event at a second location;
a computing device determining a duration of time between the end time value and the start time value;
the computing device identifying a travel time indicative of a time to travel between the first location and the second location; and
responsive to the travel time being within a threshold range, the computing device adjusting the travel time to the duration of time between the end time value and the start time value.

11. The method of claim 10, further comprising responsive to the travel time being outside of the threshold range, the computing device applying a lock to the travel time.

12. The method of claim 10, wherein identifying the travel time indicative of the time to travel between the first location and the second location comprises identifying the travel time indicative of the time to travel between the first location and the second location by receiving at least one of a global positioning system (GPS) travel time, a self-reported travel time, and a mapping service travel time.

13. The method of claim 12, further comprising:
identifying an actual travel distance indicative of a distance traveled between the first location and the second location;
determining an estimated travel distance between the first location and the second location; and
responsive to the actual travel distance exceeding the estimated travel distance by a distance threshold, applying a lock to the travel time.

14. The method of claim 13, wherein the actual travel distance is one of a self-reported travel distance and a GPS travel distance.

15. The method of claim 10, further comprising:
identifying a recorded total travel distance indicative of a total distance traveled on a day of the first care event;
determining an estimated total travel distance for a period of time associated with the first care event; and
responsive to the recorded total travel distance exceeding the estimated total travel distance by a distance threshold, applying a lock to the travel time.

16. The method of claim 10, further comprising:
identifying an alert condition associated with the first care event;
determining whether the alert condition is met; and
responsive to the alert condition being met, applying a lock to data associated with the first care event.

17. The method of claim 15, wherein the alert condition is selected from the group consisting of a delayed start value, a late finish value, a short visit value, a long visit value, and a missed visit value.

18. The method of claim 15, further comprising:
receiving data indicative of a change in the alert condition; and
responsive to the change in the alert condition, removing the lock to the data associated with the first care event.

19. The method of claim 10, wherein the threshold range includes a lower threshold representative of a minimum number of minutes between (i) the travel time between the first location and the second location and (ii) the duration of time between the end time value and the start time value.

20. The method of claim 10, wherein the threshold range includes an upper threshold representative of a maximum number of minutes between (i) the travel time between the first location and the second location and (ii) the duration of time between the end time value and the start time value.
